(19) United States
(12) Patent Application Publication
(10) Pub. No.: US 2017/0041408 A1
(43) Pub. Date: Feb. 9, 2017

(54) SYSTEMS AND METHODS FOR MANAGING SHARED CONTENT

(71) Applicant: Facebook, Inc., Menlo Park, CA (US)

(72) Inventors: Adam Kramer, San Francisco, CA (US); Sauvik Das, Tucker, GA (US)

(21) Appl. No.: 14/819,152

(22) Filed: Aug. 5, 2015

(51) Int. Cl. H04L 29/08; H04L 29/06

(52) U.S. Cl. CPC H04L 67/22; H04L 63/08

(57) ABSTRACT

Systems, methods, and non-transitory computer-readable media can determine that a content item has been shared by a first user through a computing system, wherein the shared content item is distributed to one or more other users of the computing system through respective news feeds corresponding to the one or more other users. A determination can be made that the shared content item has been selected for isolation by at least one second user. The content item can be isolated from the respective news feeds corresponding to the one or more other users, wherein the isolated content item is removed from the respective news feeds.

### FIELD OF THE INVENTION

The present technology relates to the field of content management. More particularly, the present technology relates to techniques for managing the presentation of shared content.

### BACKGROUND

Today, people often utilize computing devices for a wide variety of purposes. Users can use their computing devices, for example, to communicate and otherwise interact with other users. Such interactions are increasingly popular through a social network.

Some interactions in a social network may include the sharing of content. Content can be shared in a variety of manners. One example of a technique to share content with a user of a social network is by posting content items (i.e., posts). Such content items can include, for example, images uploaded by others in the social network of the user, descriptions of activities of connections of the user, articles regarding subject matter of interest to the user, advertisements directed to the user, etc. Posted content items can be presented through respective content feeds (e.g., news feeds) of other users of the social network. Each news feed can include a listing of content items (or stories) that are deemed appropriate for presentation to the user. The news feed for the user can include myriad types of content items.

In some instances, a user's social network account may be compromised, for example, due to the account being hacked or by malicious software (malware) such as computer viruses. In such instances, the compromising party may perform malicious activities (e.g., phishing) through the user's account, for example, by posting fraudulent or malicious content items.

### SUMMARY

Various embodiments of the present disclosure can include systems, methods, and non-transitory computer readable media configured to determine that a content item has been shared by a first user through a computing system, wherein the shared content item is distributed to one or more other users of the computing system through respective news feeds corresponding to the one or more other users. A determination can be made that the shared content item has been selected for isolation by at least one second user. The content item can be isolated from the respective news feeds corresponding to the one or more other users, wherein the isolated content item is removed from the respective news feeds.

In an embodiment, a determination can be made that the second user is authorized, by the first user, to isolate the content item.

In an embodiment, at least one method of authentication to the second user and a determination can be made that the second user has satisfied the method of authentication.

In an embodiment, access to the content item can be restricted to the first user and the second user.

In an embodiment, access to the content item can be restricted to the first user and users authorized to manage content items shared through an account of the first user.

In an embodiment, a determination can be made that the isolated content item has been selected to be reintroduced through the computing system and the isolated content item to be reintroduced can be provided through at least the respective news feeds of the one or more other users.

In an embodiment, the content item is selected to be reintroduced by the first user.

In an embodiment, the content item is selected to be reintroduced by a user authorized to manage content items shared through an account of the first user.

In an embodiment, at least one method of authentication can be provided to a user that selected the content item to be reintroduced and a determination can be made that the user has satisfied the method of authentication.

In an embodiment, a ranking score corresponding to the content item by a predetermined amount can be adjusted.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including an example content distribution module configured to distribute content items, according to an embodiment of the present disclosure.

FIG. 2 illustrates an example content management module configured to manage the distribution of content items, according to an embodiment of the present disclosure.

FIG. 3 illustrates an example interface for isolating a content item from distribution, according to an embodiment of the present disclosure.

FIG. 4 illustrates an example interface for redistributing an isolated content item, according to various embodiments of the present disclosure.

FIG. 5 illustrates an example method for isolating content items, according to an embodiment of the present disclosure.

FIG. 6 illustrates an example method for redistributing isolated content items, according to an embodiment of the present disclosure.

FIG. 7 illustrates a network diagram of an example system including an example social networking system that can be utilized in various scenarios, according to an embodiment of the present disclosure.

FIG. 8 illustrates an example of a computer system or computing device that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Approaches for Managing Shared Content

People use computing devices (or systems) for a wide variety of purposes. For example, users can use their computing devices, for example, to communicate and otherwise interact with other users through a social networking system. As mentioned, under conventional approaches, such interactions may involve the sharing of content items, for example, by posting content items (i.e., posts) for distribution to other users of the social networking system (e.g., the user's social connections). The posted content items can be accessed by, or made available to, the other users of the social networking system through their respective news feeds. As mentioned, each news feed can be a listing of content items (or stories) that are deemed appropriate for presentation to the user. In some instances, however, a user's account on the social networking system may be compromised, for example, due to the account being hacked or by malicious software (malware) such as computer viruses under conventional approaches rooted in computer technology. In such instances, the compromising party may perform fraudulent (e.g., malicious) activities (e.g., phishing) that involve posting content items, malicious or otherwise, through the user's account on the social networking system. When such instances occur, the user is typically unaware that his account was compromised until informed by other users. Typically, by the time the user removes the fraudulent content item posted through their account, the fraudulent content item has already been distributed to other users of the social networking system. Such distribution of the fraudulent content item can increase the likelihood of those other users also having their social network accounts be compromised by the malicious software.

An improved approach overcomes the foregoing and other disadvantages associated with conventional approaches. Based on computer technology, in various embodiments, a user of the social networking system can authorize one or more other users of the social networking system to manage content items that have been posted through the user's account. The authorized users may be social connections of the user, for example. When a content item is posted through the user's account, the authorized users can access the posted content item through their respective content feeds (e.g., news feeds). If any of the authorized users determine that the posted content item was posted without the user's knowledge, for example, by malicious software, then the authorized users can select an option to remove, or isolate (e.g., quarantine), the posted content item from distribution. In other words, once isolated, the content item can be removed from the respective news feeds of other users to which the content item was made available upon posting. There may be other situations in which the authorized users may want to isolate content items posted by the user. For example, an authorized user may determine that a content item posted by the user is inappropriate (e.g., not safe for work or NSFW). In this example, the authorized user can select the option to isolate the posted content item from distribution. Further, authorized users can utilize the approaches described here for social curation purposes. For example, an authorized user may determine that a content item posted by the user is may cause the user embarrassment. In such instances, the authorized user can select the option to isolate the posted content item from distribution. There may be instances where the content item posted by the user is inaccurate or contains errors (e.g., factual or grammatical). In such instances, an authorized user may determine that the content item contains such inaccuracies and/or errors and can select the option to isolate the posted content item from distribution to allow for correction of the inaccuracies and/or errors.

In various embodiments, after being isolated, the content item is still accessible by the user and any users that were authorized by the user to manage content items posted from the authorizing user's account. While in isolation, the user and the authorized users can view and discuss the isolated content item. For example, the user and authorized users can communicate with one another by posting comments with respect to the isolated content item through the social networking system. Again, since the content item is in isolation, any comments posted with respect to the content item are typically not accessible to unauthorized users. In some instances, the content item may have been isolated erroneously. For example, the authorized user that requested isolation of the content item may have inadvertently believed that the content item was fraudulent. In such instances, an option can be selected to place the content item back into circulation through the social networking system, for example, by the user of the account through which the content item was posted and/or any authorized users. For example, the user and/or authorized users can select an option to reintroduce, or re-post, the content item through the respective news feeds of other users of the social networking system. In various embodiments, the user seeking isolation of content items and/or the re-posting of content items can be required to satisfy additional authentication measures. By utilizing such an approach, fraudulent content items posted through a user's hacked account can be quickly removed from circulation thereby protecting both the user and other users of the social networking system to whom the content item would have been distributed.

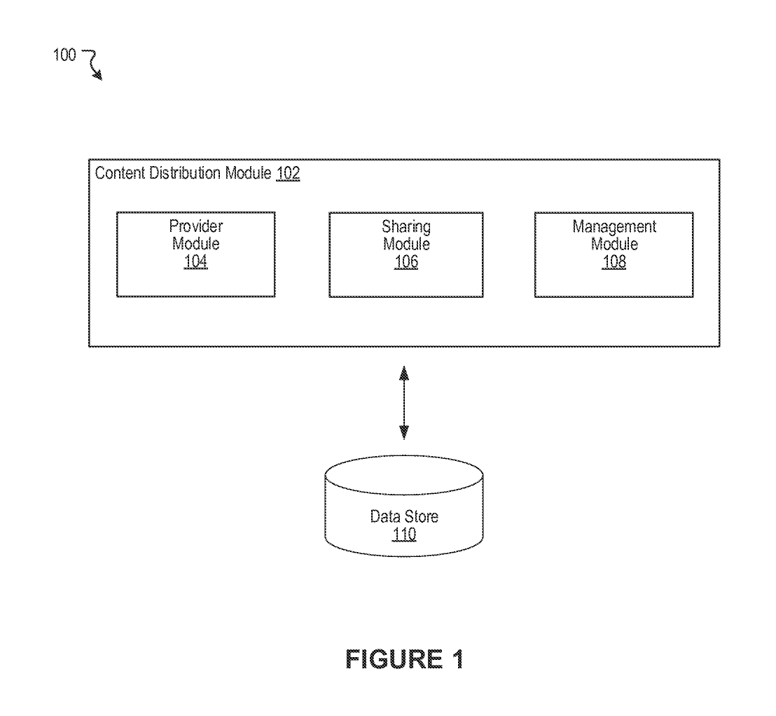

FIG. 1 illustrates an example system 100 including an example content distribution module 102 configured to distribute content items, according to an embodiment of the present disclosure. As shown in the example of FIG. 1, the content distribution module 102 can include a provider module 104, a sharing module 106, and a management module 108. In some instances, the example system 100 can include at least one data store 110. The components (e.g., modules, elements, etc.) shown in this figure and all figures herein are exemplary only, and other implementations may include additional, fewer, integrated, or different components. Some components may not be shown so as not to obscure relevant details.

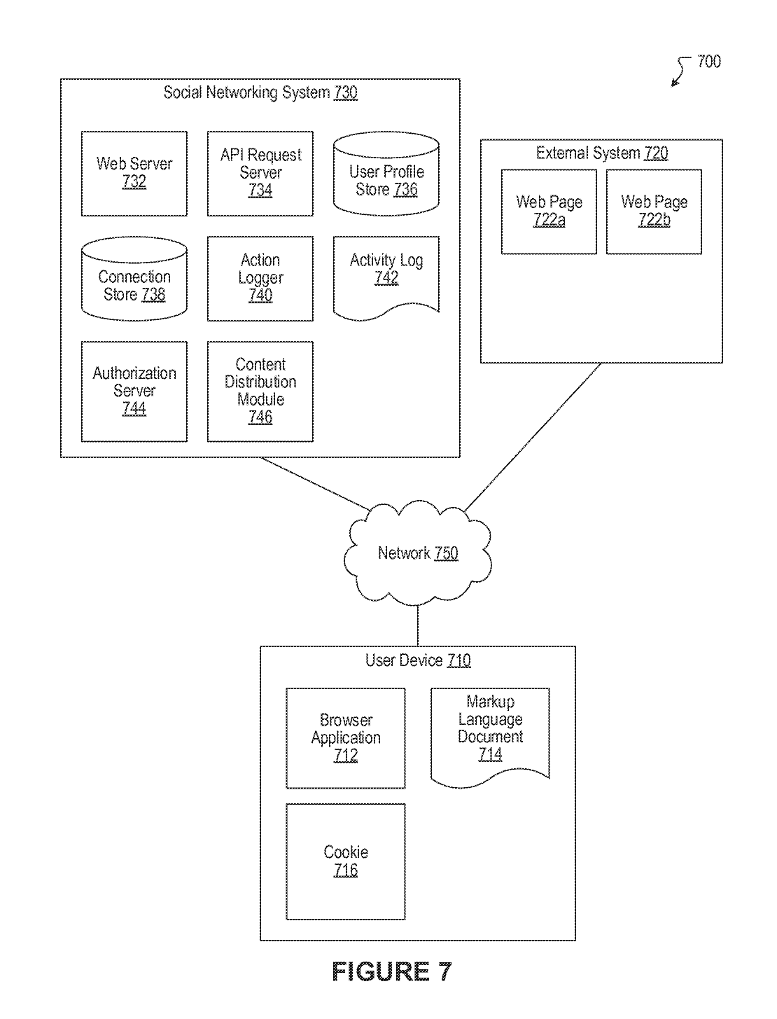

In some embodiments, the content distribution module 102 can be implemented, in part or in whole, as software, hardware, or any combination thereof. In general, a module, as discussed herein, can be associated with software, hardware, or any combination thereof. In some implementations, one or more functions, tasks, and/or operations of modules can be carried out or performed by software routines, software processes, hardware, and/or any combination thereof. In some cases, the content distribution module 102 can be implemented, in part or in whole, as software running on one or more computing devices or systems, such as on a user computing device or client computing system. For example, the content distribution module 102, or at least a portion thereof, can be implemented as or within an application (e.g., app), a program, or an applet, etc., running on a user computing device or a client computing system, such as the user device 710 of FIG. 7. Further, the content distribution module 102, or at least a portion thereof, can be implemented using one or more computing devices or systems that include one or more servers, such as network servers or cloud servers. In some instances, the content distribution module 102 can, in part or in whole, be implemented within or configured to operate in conjunction with a social networking system (or service), such as the social networking system 730 of FIG. 7. It should be understood that there can be many variations or other possibilities.

In various embodiments, the content distribution module 102 can be configured to distribute content that has been communicated (e.g., posted) by users of the social networking system. For example, a user can share (e.g., post) a content item to be distributed to other users of the social networking system (e.g., the user's social connections). The posted content items can be accessed by, or made available to, the other users of the social networking system, for example, through their respective news feeds. Posted content items can include, for example, images uploaded by other users in the social network of the user, descriptions of activities of connections of the user, articles regarding subject matter of interest to the user, advertisements directed to the user, etc.

The provider module 104 can be configured to provide users of the social networking system with access to their respective news feeds through which shared content items are made available. For example, a user can access his news feed upon providing login credentials to the social networking system. The social networking system can determine content items that are relevant, or appropriate, for the user and can include these content items in the user's news feed.

The sharing module 106 can be configured to distribute content items that have been shared by users. When sharing a content item, a user can communicate (e.g., post) the content item to the social networking system. The posted content item can be distributed by the sharing module 106 to other users of the social networking system, for example, to social connections of the user. For example, the content item can be distributed to the other users by including the content item in the respective news feeds of the other users.

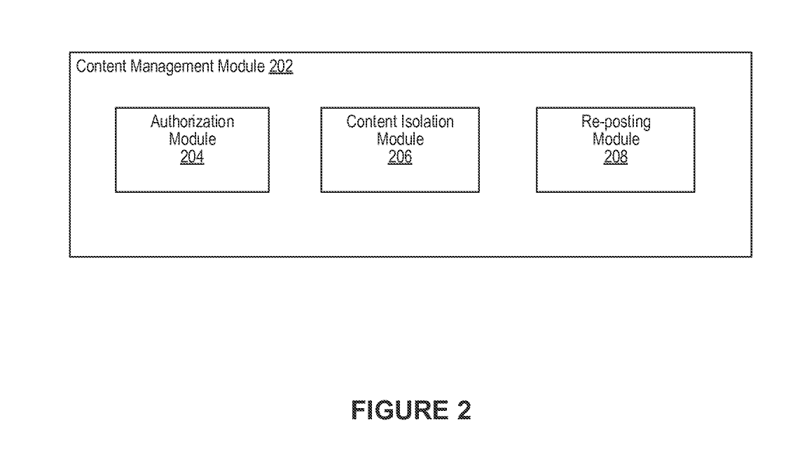

The management module 108 can be configured to manage content items that have been posted by users through their accounts with the social networking system. More details regarding the management module 108 will be provided below in reference to FIG. 2.

In some embodiments, the content distribution module 102 can be configured to communicate and/or operate with the at least one data store 110 in the example system 100. The at least one data store 110 can be configured to store and maintain various types of data. In various embodiments, the at least one data store 110 can store data relevant to function and operation of the content distribution module 102. Examples of such data are content items posted by users of the social networking system, authorization policies that specify which users are authorized to manage a given user's posts, and any authentication measures (e.g., credentials) for authenticating users that attempt to manage posts. In some implementations, the at least one data store 110 can store information associated with the social networking system (e.g., the social networking system 730 of FIG. 7). The information associated with the social networking system can include data about users, social connections, social interactions, locations, geo-fenced areas, maps, places, events, pages, groups, posts, communications, content, feeds, account settings, privacy settings, a social graph, and various other types of data. In some implementations, the at least one data store 110 can store information associated with users, such as user identifiers, user information, profile information, user specified settings, content produced or posted by users, and various other types of user data. It should be appreciated that there can be many variations or other possibilities.

FIG. 2 illustrates an example content management module 202 configured to manage the distribution of content items, according to an embodiment of the present disclosure. In some embodiments, the management module 108 of FIG. 1 can be implemented with the content management module 202. As shown in the example of FIG. 2, the content management module 202 can include an authorization module 204, a content isolation module 206, and a re-posting module 208.

The content management module 202 can be configured to manage content items that have been posted through user accounts of a social networking system. As mentioned, in some instances, access to a user account can become compromised, for example, due to the account being hacked or by malicious software. In such instances, the compromising entity or software may perform malicious activities (e.g., phishing) through the compromised account. These malicious activities may involve posting content items, fraudulent (e.g., malicious) or otherwise, through the compromised account. The user whose account was compromised is typically unaware of his account being breached until notified by another user of the social networking system. In the meantime, the fraudulent content item can be distributed by the social networking system to other users, for example, through their respective news feeds. Such distribution of the fraudulent item can cause embarrassment to the user whose account was compromised. In some instances, when the content item is malware (e.g., a computer virus), the distribution can increase the likelihood of other users also having their accounts on the social networking system be compromised.

To prevent embarrassment or further compromises of user accounts, in various embodiments, the authorization module 204 can be configured to allow users to authorize one or more other users of the social networking system to manage content items that are posted through a user's account. For example, a first user can authorize a second user to manage content items posted through the first user's account. The authorized users may, but need not be, social connections of the authorizing user. In various embodiments, the authorizing user can specify the one or more authorized users by interacting with the social networking system, for example, through a graphical user interface, such as a web browser and/or a software application running on a computing device.

When a fraudulent content item is posted through the compromised account, the authorized users can access the fraudulent content item through their respective news feeds. A content item included in a user's news feed can be presented with various options such as a “like” option that can be selected by the user to promote, or indicate an appreciation of, the content item. Another example option can be a “comment” option that allows the user to provide a comment with respect to the content item. In some embodiments, a user that is authorized to manage content items posted through another user's account can be provided with an option to remove, or isolate, the content item from distribution. When an authorized user requests isolation of a content item, the content isolation module 206 can be configured to remove the content item from circulation through the social networking system. In other words, the isolated content item can be removed from the respective news feeds of other users, such as the user's social connections, to which the content item was made available upon posting. In some embodiments, an authorized user that requests isolation of a content item may be required to satisfy one or more authentication measures that are provided by the social networking system. For example, the authorized user may need to satisfy a CAPTCHA (Completely Automated Public Turing test to tell Computers and Humans Apart) challenge-response test provided by the social networking system. In some instances, the authorized user may need to provide his login credentials to the social networking system. Naturally, other generally known techniques for authentication may be implemented.

While the content item is in isolation, the user whose account was used to post the fraudulent content item and any authorized users can still access the isolated content item. In some embodiments, access to the isolated content item can be restricted to the user whose account was used to post the fraudulent content item and the authorized user that requested isolation of the content item. By restricting access as such, the viewing of, and any interaction with, the content item (e.g., “liking”, posting comments, etc.) is restricted to the user whose account was used to post the fraudulent content item and the authorized user. In some instances, the content item can be accessed through the social networking system by accessing a Uniform Resource Locator (URL) or permalink, for example. The isolated content item can be associated with a “comment” option that allows the user and the authorized users to post comments with respect to the content item. Access to these comments can be restricted to the user and the authorized users while the content item is in isolation. Through their comments, the user and/or the authorized users can discuss, for example, reasons for removing the content item from circulation and resolve any confusion that may exist.

In some embodiments, if the user and/or any authorized users determine that the content item should not have been isolated, then the user and/or any authorized users can select an option for reintroducing, or re-posting, the isolated content item through the social networking system. The re-posting module 208 can be configured to reintroduce, or re-post, the content item so that the content item is made available through the social networking system and in the respective news feeds from which it was removed. In some embodiments, when a content item is selected to be reintroduced or re-posted, the re-posting module 208 can be configured to allow the user whose account was used to post the content item to delete some, or all, of the comments that were posted with respect to the content item while the content item was in isolation. In some embodiments, a ranking score corresponding to the content item being reintroduced is adjusted, or boosted, by a predetermined amount so that the ranking of the content item in news feeds is increased.

In some embodiments, the user that requests re-posting an isolated content item may be required to satisfy one or more authentication measures that are provided by the re-posting module 208. For example, the authorized user may need to satisfy a CAPTCHA (Completely Automated Public Turing test to tell Computers and Humans Apart) challenge-response test provided by the re-posting module 208. In some instances, the user may need to provide their login credentials to the re-posting module 208. Other generally known techniques for authentication may be implemented.

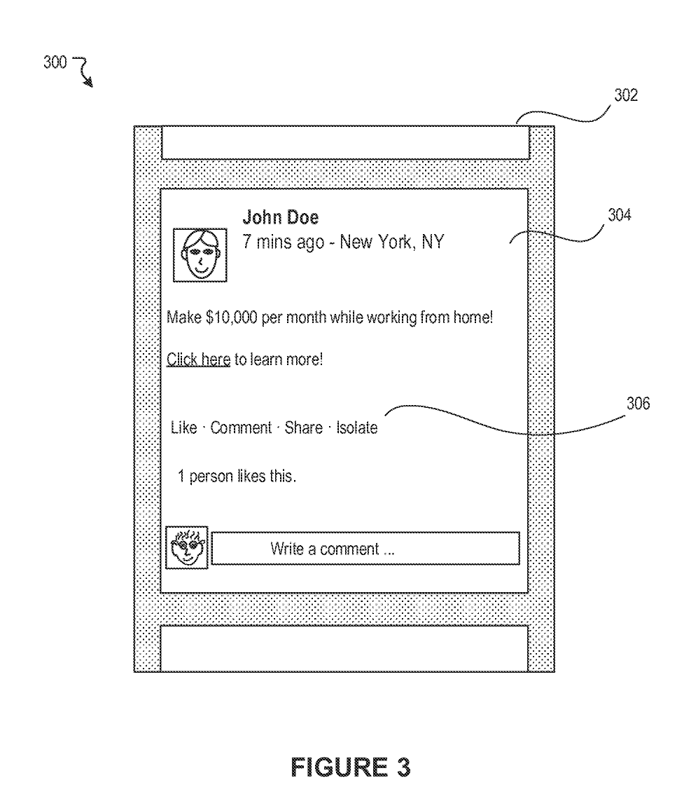

FIG. 3 illustrates an example interface 300 for isolating a content item 304 from distribution, according to an embodiment of the present disclosure. In the example of FIG. 3, the content item 304, which was posted by a user “John Doe” through a social networking system, is shown as being included in a news feed 302 of a user “Tim O'Toole” who, in this example, is a social connection of the user John Doe.

In this example, John Doe has authorized Tim O'Toole to manage any content items that are posted through John Doe's account on the social networking system. As a result, Tim O'Toole is presented with an option 306 to remove, or isolate, the content item 304 from distribution. Upon reviewing the content item 304, Tim O'Toole may determine that the content item 304 is fraudulent. In this instance, Tim O'Toole can select the option 306 to isolate the content item 304.

Once isolated, the content item 304 can be removed from circulation through the social networking system. Consequently, in addition to the news feed 302, the isolated content item can be removed from the respective news feeds of other users to which the content item was made available upon posting, such as the user's social connections. As mentioned, the content item 304 can still be accessible by John Doe, whose account was used to post the content item 304 and any authorized users (e.g., Tim O'Toole), for example, through a separate interface (e.g., permalink).

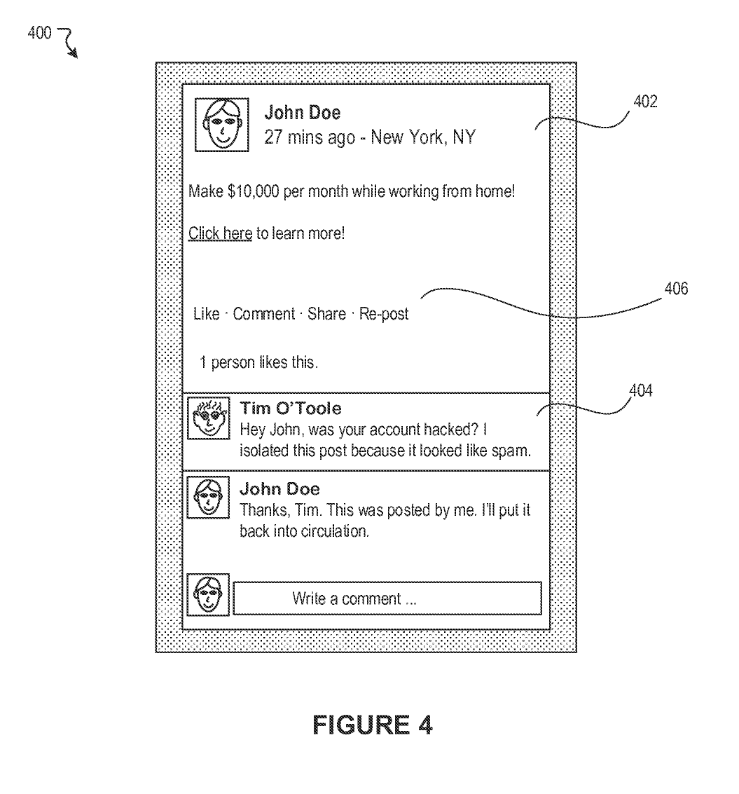

FIG. 4 illustrates an example interface 400 for redistributing an isolated content item 402, according to various embodiments of the present disclosure. In the example of FIG. 4, the content item 402, which was posted by a user “John Doe” through a social networking system, was selected to be isolated by a user “Tim O'Toole” who is authorized to manage posts made through John Doe's account. Since the content item 402 is isolated, the content item 402 is not included in any news feeds provided through the social networking system and access to the content item 402 can be restricted to John Doe and Tim O'Toole. In some embodiments, the content item 402 can also be accessed by any other user that has been authorized to manage posts made through John Doe's account.

The example interface 400 can be accessed through a URL or permalink, for example. Further, users can post comments 404 with respect to the content item 402 to discuss the content item 402 and reasons for isolating and/or reintroducing the content item 402 back into circulation through the social networking system. If the user and/or any authorized users determine that the content item 402 should not have been isolated, then the user and/or any authorized users can select an option 406 for reintroducing, or re-posting, the isolated content item through the social networking system. Once the option 406 is selected, the content item 402 can be reintroduced, or re-posted, so that the content item 402 can be made available through the social networking system and in the respective news feeds from which it was removed. In various embodiments, the user (e.g., John Doe) seeking isolation of content items and/or the re-posting of content items can be required to satisfy additional authentication measures, as described above. In some embodiments, when a content item 402 is selected to be reintroduced or re-posted, the user whose account was used to post the content item, i.e., John Doe, can delete some, or all, of the comments 404 while the content item was in isolation.

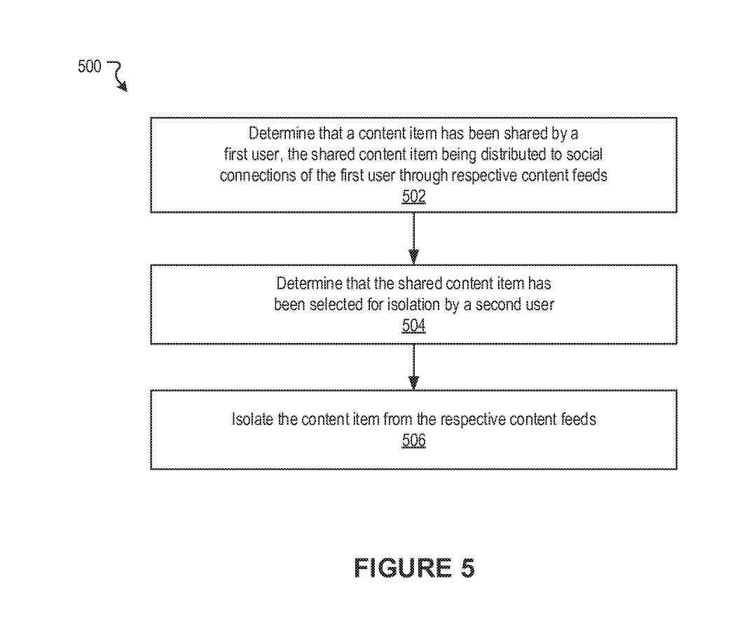

FIG. 5 illustrates an example method 500 for isolating content items, according to an embodiment of the present disclosure. It should be appreciated that there can be additional, fewer, or alternative steps performed in similar or alternative orders, or in parallel, within the scope of the various embodiments discussed herein unless otherwise stated.

At block 502, the example method 500 can determine that a content item has been shared by a first user, for example, through a social networking system. The shared content item can be distributed to other users (e.g., social connections of the first user) through respective content, or news, feeds corresponding to the other users. At block 504, the method 500 can determine that the shared content item has been selected to be isolated by a second user of the social networking system. The second user can be authorized by the first user to manage, or isolate, content items that are shared through the first user's account on the social networking system, for example. At block 506, the method 500 can isolate the content item from the respective content, or news, feeds through which the content item would otherwise be made available.

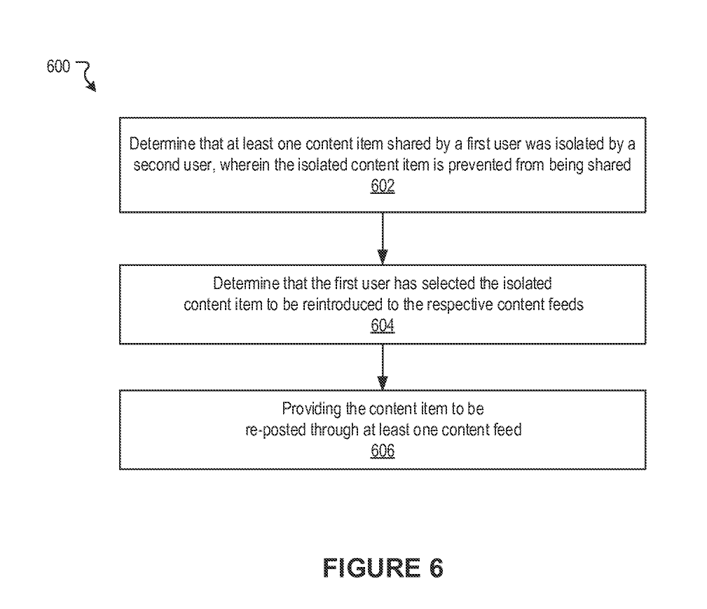

FIG. 6 illustrates an example method 600 for redistributing isolated content items, according to an embodiment of the present disclosure. It should be appreciated that there can be additional, fewer, or alternative steps performed in similar or alternative orders, or in parallel, within the scope of the various embodiments discussed herein unless otherwise stated.

At block 602, the example method 600 can determine that at least one content item shared by a first user through a social networking system was selected for isolation by a second user of the social networking system. Upon being isolated, the content item can be removed from circulation through the social networking system and be removed from any content, or news, feeds through which the content item would otherwise be shared. At block 604, the method 600 can determine that the first user has selected an option for reintroducing, or re-posting, the isolated content item through the social networking system. At block 606, the method 600 can provide the content item to be reintroduced, or re-posted, through the social networking system in at least one content, or news, feed of a user of the social networking system.

It is contemplated that there can be many other uses, applications, and/or variations associated with the various embodiments of the present disclosure. For example, in some cases, user can choose whether or not to opt-in to utilize the disclosed technology. The disclosed technology can also ensure that various privacy settings and preferences are maintained and can prevent private information from being divulged. In another example, various embodiments of the present disclosure can learn, improve, and/or be refined over time.

### Social Networking System—Example Implementation

FIG. 7 illustrates a network diagram of an example system 700 that can be utilized in various scenarios, in accordance with an embodiment of the present disclosure. The system 700 includes one or more user devices 710, one or more external systems 720, a social networking system (or service) 730, and a network 750. In an embodiment, the social networking service, provider, and/or system discussed in connection with the embodiments described above may be implemented as the social networking system 730. For purposes of illustration, the embodiment of the system 700, shown by FIG. 7, includes a single external system 720 and a single user device 710. However, in other embodiments, the system 700 may include more user devices 710 and/or more external systems 720. In certain embodiments, the social networking system 730 is operated by a social network provider, whereas the external systems 720 are separate from the social networking system 730 in that they may be operated by different entities. In various embodiments, however, the social networking system 730 and the external systems 720 operate in conjunction to provide social networking services to users (or members) of the social networking system 730. In this sense, the social networking system 730 provides a platform or backbone, which other systems, such as external systems 720, may use to provide social networking services and functionalities to users across the Internet.

The user device 710 comprises one or more computing devices (or systems) that can receive input from a user and transmit and receive data via the network 750. In one embodiment, the user device 710 is a conventional computer system executing, for example, a Microsoft Windows compatible operating system (OS), Apple OS X, and/or a Linux distribution. In another embodiment, the user device 710 can be a computing device or a device having computer functionality, such as a smart-phone, a tablet, a personal digital assistant (PDA), a mobile telephone, a laptop computer, a wearable device (e.g., a pair of glasses, a watch, a bracelet, etc.), a camera, an appliance, etc. The user device 710 is configured to communicate via the network 750. The user device 710 can execute an application, for example, a browser application that allows a user of the user device 710 to interact with the social networking system 730. In another embodiment, the user device 710 interacts with the social networking system 730 through an application programming interface (API) provided by the native operating system of the user device 710, such as iOS and ANDROID. The user device 710 is configured to communicate with the external system 720 and the social networking system 730 via the network 750, which may comprise any combination of local area and/or wide area networks, using wired and/or wireless communication systems.

In one embodiment, the network 750 uses standard communications technologies and protocols. Thus, the network 750 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 750 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 750 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 710 may display content from the external system 720 and/or from the social networking system 730 by processing a markup language document 714 received from the external system 720 and from the social networking system 730 using a browser application 712. The markup language document 714 identifies content and one or more instructions describing formatting or presentation of the content. By executing the instructions included in the markup language document 714, the browser application 712 displays the identified content using the format or presentation described by the markup language document 714. For example, the markup language document 714 includes instructions for generating and displaying a web page having multiple frames that include text and/or image data retrieved from the external system 720 and the social networking system 730. In various embodiments, the markup language document 714 comprises a data file including extensible markup language (XML) data, extensible hypertext markup language (XHTML) data, or other markup language data. Additionally, the markup language document 714 may include JavaScript Object Notation (JSON) data, JSON with padding (JSONP), and JavaScript data to facilitate data-interchange between the external system 720 and the user device 710. The browser application 712 on the user device 710 may use a JavaScript compiler to decode the markup language document 714.

The markup language document 714 may also include, or link to, applications or application frameworks such as FLASH™ or Unity™ applications, the Silverlight™ application framework, etc.

In one embodiment, the user device 710 also includes one or more cookies 716 including data indicating whether a user of the user device 710 is logged into the social networking system 730, which may enable modification of the data communicated from the social networking system 730 to the user device 710.

The external system 720 includes one or more web servers that include one or more web pages 722a, 722b, which are communicated to the user device 710 using the network 750. The external system 720 is separate from the social networking system 730. For example, the external system 720 is associated with a first domain, while the social networking system 730 is associated with a separate social networking domain. Web pages 722a, 722b, included in the external system 720, comprise markup language documents 714 identifying content and including instructions specifying formatting or presentation of the identified content. As discussed previously, it should be appreciated that there can be many variations or other possibilities.

The social networking system 730 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 730 may be administered, managed, or controlled by an operator. The operator of the social networking system 730 may be a human being, an automated application, or a series of applications for managing content, regulating policies, and collecting usage metrics within the social networking system 730. Any type of operator may be used.

Users may join the social networking system 730 and then add connections to any number of other users of the social networking system 730 to whom they desire to be connected. As used herein, the term “friend” refers to any other user of the social networking system 730 to whom a user has formed a connection, association, or relationship via the social networking system 730. For example, in an embodiment, if users in the social networking system 730 are represented as nodes in the social graph, the term “friend” can refer to an edge formed between and directly connecting two user nodes.

Connections may be added explicitly by a user or may be automatically created by the social networking system 730 based on common characteristics of the users (e.g., users who are alumni of the same educational institution). For example, a first user specifically selects a particular other user to be a friend. Connections in the social networking system 730 are usually in both directions, but need not be, so the terms “user” and “friend” depend on the frame of reference. Connections between users of the social networking system 730 are usually bilateral (“two-way”), or “mutual,” but connections may also be unilateral, or “one-way.” For example, if Bob and Joe are both users of the social networking system 730 and connected to each other, Bob and Joe are each other's connections. If, on the other hand, Bob wishes to connect to Joe to view data communicated to the social networking system 730 by Joe, but Joe does not wish to form a mutual connection, a unilateral connection may be established. The connection between users may be a direct connection; however, some embodiments of the social networking system 730 allow the connection to be indirect via one or more levels of connections or degrees of separation.

In addition to establishing and maintaining connections between users and allowing interactions between users, the social networking system 730 provides users with the ability to take actions on various types of items supported by the social networking system 730. These items may include groups or networks (i.e., social networks of people, entities, and concepts) to which users of the social networking system 730 may belong, events or calendar entries in which a user might be interested, computer-based applications that a user may use via the social networking system 730, transactions that allow users to buy or sell items via services provided by or through the social networking system 730, and interactions with advertisements that a user may perform on or off the social networking system 730. These are just a few examples of the items upon which a user may act on the social networking system 730, and many others are possible. A user may interact with anything that is capable of being represented in the social networking system 730 or in the external system 720, separate from the social networking system 730, or coupled to the social networking system 730 via the network 750.

The social networking system 730 is also capable of linking a variety of entities. For example, the social networking system 730 enables users to interact with each other as well as external systems 720 or other entities through an API, a web service, or other communication channels. The social networking system 730 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 730. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 730 modifies edges connecting the various nodes to reflect the relationships and interactions.

The social networking system 730 also includes user-generated content, which enhances a user's interactions with the social networking system 730. User-generated content may include anything a user can add, upload, send, or “post” to the social networking system 730. For example, a user communicates posts to the social networking system 730 from a user device 710. Posts may include data such as status updates or other textual data, location information, images such as photos, videos, links, music or other similar data and/or media. Content may also be added to the social networking system 730 by a third party. Content “items” are represented as objects in the social networking system 730. In this way, users of the social networking system 730 are encouraged to communicate with each other by posting text and content items of various types of media through various communication channels. Such communication increases the interaction of users with each other and increases the frequency with which users interact with the social networking system 730.

The social networking system 730 includes a web server 732, an API request server 734, a user profile store 736, a connection store 738, an action logger 740, an activity log 742, and an authorization server 744. In an embodiment of the invention, the social networking system 730 may include additional, fewer, or different components for various applications. Other components, such as network interfaces, security mechanisms, load balancers, failover servers, management and network operations consoles, and the like are not shown so as to not obscure the details of the system.

The user profile store 736 maintains information about user accounts, including biographic, demographic, and other types of descriptive information, such as work experience, educational history, hobbies or preferences, location, and the like that has been declared by users or inferred by the social networking system 730. This information is stored in the user profile store 736 such that each user is uniquely identified. The social networking system 730 also stores data describing one or more connections between different users in the connection store 738. The connection information may indicate users who have similar or common work experience, group memberships, hobbies, or educational history. Additionally, the social networking system 730 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 730, such as non-person entities, buckets, cluster centers, images, interests, pages, external systems, concepts, and the like are also stored in the connection store 738.

The social networking system 730 maintains data about objects with which a user may interact. To maintain this data, the user profile store 736 and the connection store 738 store instances of the corresponding type of objects maintained by the social networking system 730. Each object type has information fields that are suitable for storing information appropriate to the type of object. For example, the user profile store 736 contains data structures with fields suitable for describing a user's account and information related to a user's account. When a new object of a particular type is created, the social networking system 730 initializes a new data structure of the corresponding type, assigns a unique object identifier to it, and begins to add data to the object as needed. This might occur, for example, when a user becomes a user of the social networking system 730, the social networking system 730 generates a new instance of a user profile in the user profile store 736, assigns a unique identifier to the user account, and begins to populate the fields of the user account with information provided by the user.

The connection store 738 includes data structures suitable for describing a user's connections to other users, connections to external systems 720 or connections to other entities. The connection store 738 may also associate a connection type with a user's connections, which may be used in conjunction with the user's privacy setting to regulate access to information about the user. In an embodiment of the invention, the user profile store 736 and the connection store 738 may be implemented as a federated database.

Data stored in the connection store 738, the user profile store 736, and the activity log 742 enables the social networking system 730 to generate the social graph that uses nodes to identify various objects and edges connecting nodes to identify relationships between different objects. For example, if a first user establishes a connection with a second user in the social networking system 730, user accounts of the first user and the second user from the user profile store 736 may act as nodes in the social graph. The connection between the first user and the second user stored by the connection store 738 is an edge between the nodes associated with the first user and the second user. Continuing this example, the second user may then send the first user a message within the social networking system 730. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 730 (or, alternatively, in an image maintained by another system outside of the social networking system 730). The image may itself be represented as a node in the social networking system 730. This tagging action may create edges between the first user and the second user as well as create an edge between each of the users and the image, which is also a node in the social graph. In yet another example, if a user confirms attending an event, the user and the event are nodes obtained from the user profile store 736, where the attendance of the event is an edge between the nodes that may be retrieved from the activity log 742. By generating and maintaining the social graph, the social networking system 730 includes data describing many different types of objects and the interactions and connections among those objects, providing a rich source of socially relevant information.

The web server 732 links the social networking system 730 to one or more user devices 710 and/or one or more external systems 720 via the network 750. The web server 732 serves web pages, as well as other web-related content, such as Java, JavaScript, Flash, XML, and so forth. The web server 732 may include a mail server or other messaging functionality for receiving and routing messages between the social networking system 730 and one or more user devices 710. The messages can be instant messages, queued messages (e.g., email), text and SMS messages, or any other suitable messaging format.

The API request server 734 allows one or more external systems 720 and user devices 710 to call access information from the social networking system 730 by calling one or more API functions. The API request server 734 may also allow external systems 720 to send information to the social networking system 730 by calling APIs. The external system 720, in one embodiment, sends an API request to the social networking system 730 via the network 750, and the API request server 734 receives the API request. The API request server 734 processes the request by calling an API associated with the API request to generate an appropriate response, which the API request server 734 communicates to the external system 720 via the network 750. For example, responsive to an API request, the API request server 734 collects data associated with a user, such as the user's connections that have logged into the external system 720, and communicates the collected data to the external system 720. In another embodiment, the user device 710 communicates with the social networking system 730 via APIs in the same manner as external systems 720.

The action logger 740 is capable of receiving communications from the web server 732 about user actions on and/or off the social networking system 730. The action logger 740 populates the activity log 742 with information about user actions, enabling the social networking system 730 to discover various actions taken by its users within the social networking system 730 and outside of the social networking system 730. Any action that a particular user takes with respect to another node on the social networking system 730 may be associated with each user's account, through information maintained in the activity log 742 or in a similar database or other data repository. Examples of actions taken by a user within the social networking system 730 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 730, the action is recorded in the activity log 742. In one embodiment, the social networking system 730 maintains the activity log 742 as a database of entries. When an action is taken within the social networking system 730, an entry for the action is added to the activity log 742. The activity log 742 may be referred to as an action log.

Additionally, user actions may be associated with concepts and actions that occur within an entity outside of the social networking system 730, such as an external system 720 that is separate from the social networking system 730. For example, the action logger 740 may receive data describing a user's interaction with an external system 720 from the web server 732. In this example, the external system 720 reports a user's interaction according to structured actions and objects in the social graph.

Other examples of actions where a user interacts with an external system 720 include a user expressing an interest in an external system 720 or another entity, a user posting a comment to the social networking system 730 that discusses an external system 720 or a web page 722a within the external system 720, a user posting to the social networking system 730 a Uniform Resource Locator (URL) or other identifier associated with an external system 720, a user attending an event associated with an external system 720, or any other action by a user that is related to an external system 720. Thus, the activity log 742 may include actions describing interactions between a user of the social networking system 730 and an external system 720 that is separate from the social networking system 730.

The authorization server 744 enforces one or more privacy settings of the users of the social networking system 730. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 720, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 720. One embodiment allows the specification of the set of entities to comprise an enumeration of entities. For example, the user may provide a list of external systems 720 that are allowed to access certain information. Another embodiment allows the specification to comprise a set of entities along with exceptions that are not allowed to access the information. For example, a user may allow all external systems 720 to access the user's work information, but specify a list of external systems 720 that are not allowed to access the work information. Certain embodiments call the list of exceptions that are not allowed to access certain information a “block list”. External systems 720 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 744 contains logic to determine if certain information associated with a user can be accessed by a user's friends, external systems 720, and/or other applications and entities. The external system 720 may need authorization from the authorization server 744 to access the user's more private and sensitive information, such as the user's work phone number. Based on the user's privacy settings, the authorization server 744 determines if another user, the external system 720, an application, or another entity is allowed to access information associated with the user, including information about actions taken by the user.

In some embodiments, the social networking system 730 can include a content distribution module 746. The content distribution module 746 can, for example, be implemented as the content distribution module 102 of FIG. 1. As discussed previously, it should be appreciated that there can be many variations or other possibilities.

### Hardware Implementation

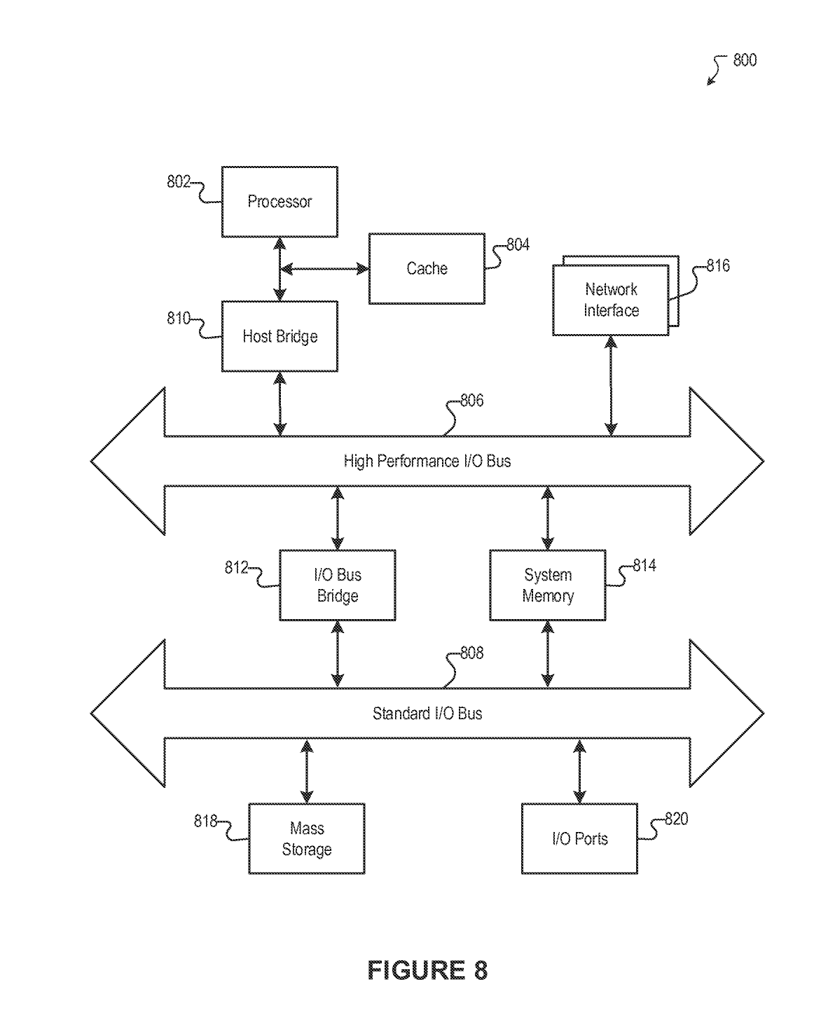

The foregoing processes and features can be implemented by a wide variety of machine and computer system architectures and in a wide variety of network and computing environments. FIG. 8 illustrates an example of a computer system 800 that may be used to implement one or more of the embodiments described herein in accordance with an embodiment of the invention. The computer system 800 includes sets of instructions for causing the computer system 800 to perform the processes and features discussed herein. The computer system 800 may be connected (e.g., networked) to other machines. In a networked deployment, the computer system 800 may operate in the capacity of a server machine or a client machine in a client-server network environment, or as a peer machine in a peer-to-peer (or distributed) network environment. In an embodiment of the invention, the computer system 800 may be the social networking system 730, the user device 710, and the external system 820, or a component thereof. In an embodiment of the invention, the computer system 800 may be one server among many that constitutes all or part of the social networking system 730.

The computer system 800 includes a processor 802, a cache 804, and one or more executable modules and drivers, stored on a computer-readable medium, directed to the processes and features described herein. Additionally, the computer system 800 includes a high performance input/output (I/O) bus 806 and a standard I/O bus 808. A host bridge 810 couples processor 802 to high performance I/O bus 806, whereas I/O bus bridge 812 couples the two buses 806 and 808 to each other. A system memory 814 and one or more network interfaces 816 couple to high performance I/O bus 806. The computer system 800 may further include video memory and a display device coupled to the video memory (not shown). Mass storage 818 and I/O ports 820 couple to the standard I/O bus 808. The computer system 800 may optionally include a keyboard and pointing device, a display device, or other input/output devices (not shown) coupled to the standard I/O bus 808. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 800, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 800 are described in greater detail below. In particular, the network interface 816 provides communication between the computer system 800 and any of a wide range of networks, such as an Ethernet (e.g., IEEE 802.3) network, a backplane, etc. The mass storage 818 provides permanent storage for the data and programming instructions to perform the above-described processes and features implemented by the respective computing systems identified above, whereas the system memory 814 (e.g., DRAM) provides temporary storage for the data and programming instructions when executed by the processor 802. The I/O ports 820 may be one or more serial and/or parallel communication ports that provide communication between additional peripheral devices, which may be coupled to the computer system 800.

The computer system 800 may include a variety of system architectures, and various components of the computer system 800 may be rearranged. For example, the cache 804 may be on-chip with processor 802. Alternatively, the cache 804 and the processor 802 may be packed together as a “processor module”, with processor 802 being referred to as the “processor core”. Furthermore, certain embodiments of the invention may neither require nor include all of the above components. For example, peripheral devices coupled to the standard I/O bus 808 may couple to the high performance I/O bus 806. In addition, in some embodiments, only a single bus may exist, with the components of the computer system 800 being coupled to the single bus. Moreover, the computer system 800 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 800 that, when read and executed by one or more processors, cause the computer system 800 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 800, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 802. Initially, the series of instructions may be stored on a storage device, such as the mass storage 818. However, the series of instructions can be stored on any suitable computer readable storage medium. Furthermore, the series of instructions need not be stored locally, and could be received from a remote storage device, such as a server on a network, via the network interface 816. The instructions are copied from the storage device, such as the mass storage 818, into the system memory 814 and then accessed and executed by the processor 802. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 800 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
determining, by a computing system, that a content item has been shared by a first user through the computing system, wherein the shared content item is distributed to one or more other users of the computing system through respective news feeds corresponding to the one or more other users;
determining, by the computing system, that the shared content item has been selected for isolation by at least one second user; and
isolating, by the computing system, the content item from the respective news feeds corresponding to the one or more other users, wherein the isolated content item is removed from the respective news feeds.

2. The computer-implemented method of claim 1, wherein determining, by the computing system, that the shared content item has been selected for isolation by at least one second user further comprises:
determining, by the computing system, that the second user is authorized, by the first user, to isolate the content item.

3. The computer-implemented method of claim 1, wherein determining, by the computing system, that the shared content item has been selected for isolation by at least one second user further comprises:
providing, by the computing system, at least one method of authentication to the second user; and
determining, by the computing system, that the second user has satisfied the method of authentication.

4. The computer-implemented method of claim 1, wherein isolating, by the computing system, the content item further comprises:
restricting, by the computing system, access to the content item to the first user and the second user.

5. The computer-implemented method of claim 1, wherein isolating, by the computing system, the content item further comprises:
restricting, by the computing system, access to the content item to the first user and users authorized to manage content items shared through an account of the first user.

6. The computer-implemented method of claim 1, the method further comprising:
determining, by the computing system, that the isolated content item has been selected to be reintroduced through the computing system; and
providing, by the computing, system, the isolated content item to be reintroduced through at least the respective news feeds of the one or more other users.

7. The computer-implemented method of claim 6, wherein the content item is selected to be reintroduced by the first user.

8. The computer-implemented method of claim 6, wherein the content item is selected to be reintroduced by a user authorized to manage content items shared through an account of the first user.

9. The computer-implemented method of claim 6, wherein determining, by the computing system, that the isolated content item has been selected to be reintroduced further comprises:
providing, by the computing system, at least one method of authentication to a user that selected the content item to be reintroduced; and
determining, by the computing system, that the user has satisfied the method of authentication.

10. The computer-implemented method of claim 6, the method further comprising:
obtaining, by the computing system, an adjusted ranking corresponding to the reintroduced content item to promote the content item in the respective news feeds of the one or more users.

11. A system comprising:
at least one processor; and
a memory storing instructions that, when executed by the at least one processor, cause the system to perform:
determining that a content item has been shared by a first user through the system, wherein the shared content item is distributed to one or more other users of the system through respective news feeds corresponding to the one or more other users;
determining that the shared content item has been selected for isolation by at least one second user; and
isolating the content item from the respective news feeds corresponding to the one or more other users, wherein the isolated content item is removed from the respective news feeds.

12. The system of claim 11, wherein determining that the shared content item has been selected for isolation by at least one second user further causes the system to perform:
determining that the second user is authorized, by the first user, to isolate the content item.

13. The system of claim 11, wherein determining that the shared content item has been selected for isolation by at least one second user further causes the system to perform:
providing at least one method of authentication to the second user; and
determining that the second user has satisfied the method of authentication.

14. The system of claim 11, wherein isolating the content item further causes the system to perform:
restricting access to the content item to the first user and the second user.

15. The system of claim 11, wherein isolating the content item further causes the system to perform:
restricting access to the content item to the first user and users authorized to manage content items shared through an account of the first user.

16. A non-transitory computer-readable storage medium including instructions that, when executed by at least one processor of a computing system, cause the computing system to perform a method comprising:
determining that a content item has been shared by a first user through the computing system, wherein the shared content item is distributed to one or more other users of the computing system through respective news feeds corresponding to the one or more other users;
determining that the shared content item has been selected for isolation by at least one second user; and
isolating the content item from the respective news feeds corresponding to the one or more other users, wherein the isolated content item is removed from the respective news feeds.

17. The non-transitory computer-readable storage medium of claim 16, wherein determining that the shared content item has been selected for isolation by at least one second user further comprises:
determining that the second user is authorized, by the first user, to isolate the content item.

18. The non-transitory computer-readable storage medium of claim 16, wherein determining that the shared content item has been selected for isolation by at least one second user further comprises:
providing at least one method of authentication to the second user; and
determining that the second user has satisfied the method of authentication.

19. The non-transitory computer-readable storage medium of claim 16, wherein isolating the content item further comprises:
restricting access to the content item to the first user and the second user.

20. The non-transitory computer-readable storage medium of claim 16, wherein isolating the content item further comprises:
restricting access to the content item to the first user and users authorized to manage content items shared through an account of the first user.
